(19) United States
(12) Patent Application Publication
(10) Pub. No.: US 2014/0028984 A1
(43) Pub. Date: Jan. 30, 2014

(54) LIGHT SOURCE APPARATUS AND PROJECTION DISPLAY APPARATUS

(71) Applicant: Akihiro Osaka, Tokyo (JP)

(72) Inventor: Akihiro Osaka, Tokyo (JP)

(21) Appl. No.: 14/009,520

(22) PCT Filed: Apr. 5, 2011
(86) PCT No.: PCT/JP2011/058617

§ 371 Date: Oct. 2, 2013

(51) Int. Cl. G03B 21/14; G02B 26/00

(52) U.S. Cl. CPC G03B 21/142; G02B 26/008
USPC 353/31; 362/84

(57) ABSTRACT

A light source apparatus for illuminating an image formation element, includes: a substrate; a driving source that rotates the substrate; a groove formed on a surface of the substrate so as to surround a rotational axis of the substrate; a phosphor layer formed in the groove; a laser light source that emits laser light delivered to the phosphor layer; and an optical system that guides first light emitted from the phosphor layer excited by the laser light, to the image formation element.

### TECHNICAL FIELD

The present invention relates to a light source, and in particular, to a light source suitable for a projection display apparatus.

### BACKGROUND ART

As light sources for projection display devices, discharge lamps have been used such as extra high pressure mercury lamps, metal halide lamps, and xenon lamps. However, in recent years, solid light sources such as light-emitting diodes (LED) and laser diodes (LD) have been receiving attention as next-generation light sources.

When a laser diode is used as a light source for a projection display apparatus, the direct use of laser light is not preferable for safety reasons, and laser light is preferably converted into incoherent light before use. Preferably, for example, a phosphor is excited by laser light emitted from the laser diode so that light released from the excited phosphor is utilized. Thus, a light source has been proposed which includes a laser diode and a substrate with a phosphor layer formed thereon and irradiated with laser light emitted from the laser diode.

However, laser light that is delivered to the phosphor layer has the power of several watts to several tens of watts. Furthermore, the spot size of the laser light that is delivered to the phosphor layer is very small (about 1.0 mm²). Thus, when one point on the phosphor layer is continuously irradiated with laser light, the phosphor or a binder that is contained in the phosphor may be damaged by heat.

Thus, a light source device has been proposed which includes color wheel 1 as shown in FIG. 1 or FIG. 2. Color wheel 1 shown in FIG. 1 or FIG. 2 includes circular substrate 2 and motor 3 for rotating circular substrate 2. Furthermore, a surface of illustrated circular substrate 2 is divided into a first segment area and a second segment area.

In the first segment area of circular substrate 2 shown in FIG. 1, green phosphor layer 4 is formed which emits green light by being excited by laser light. In the second segment area, red phosphor layer 5 is formed which emits red light by being excited by laser light.

In the first segment area of circular substrate 2 shown in FIG. 2, green phosphor layer 4 is formed which emits green light by being excited by laser light. In the second segment area, diffusion layer 6 is formed.

In color wheel 1 shown in FIG. 1 or FIG. 2, the phosphor layer is formed on circular substrate 2 that is continuously rotated. This prevents a single point on the phosphor layer from being continuously irradiated with laser light, and avoids a thermal loss in the phosphor or the binder that is contained in the phosphor.

### CITATION LIST

### Patent Literature

Patent Literature 1: JP2009-277516A
Patent Literature 2: JP2011-013313A

### SUMMARY OF INVENTION

### Technical Program

The efficiency of light utilization in a projection display device as a whole depends significantly on matching between the etendue of an illumination optical system and the etendue of a projection optical system.

When a DMD (Digital Micro-mirror Device) is used as an image formation element for the projection display device, a polarizing direction of light illuminating the DMD need not be aligned. In such a case, the etendue (E_{Light}) of the illumination optical system matches the etendue (E_{MD}) of the projection optical system when the following formula holds true.

E_{Light}≦E_{MD}

Furthermore, when a liquid crystal panel is used as an image formation element for the projection display device, the polarizing direction of light illuminating the liquid crystal panel needs to be aligned. In such a case, the etendue (E_{Light}) of the illumination optical system is effectively doubled. Hence, the etendue (E_{Light}) of the illumination optical system matches the etendue (E_{LCD}) of the projection optical system when the following formula holds true.

2E_{Light}≦E_{LCD}

Thus, in order to match the etendue of the illumination optical system with the etendue of the projection optical system, the etendue of the illumination optical system is desirably reduced.

However, light that is released from the phosphor that is excited by laser light scatters. Thus, as shown in FIG. 3, diameter (D1) of light 12 that is emitted from phosphor layer 11 that is formed on substrate 10 is larger than spot size (D2) of laser light 13. In other words, light emission area of phosphor layer 11 is larger than the irradiated area of the phosphor layer irradiated with the laser light. Thus, when an illumination optical system is configured using a light source device with color wheel 1 shown in FIG. 1 or FIG. 2, it is difficult to match the etendue of the illumination optical system with the etendue of the projection optical system.

An object of the present invention is to reduce, as much as possible, the etendue of the light source apparatus using a laser light source, thus improving the efficiency of light utilization in a projection display apparatus.

### Solution to Problem

A light source apparatus for illuminating an image formation element, includes: a substrate; a driving source that rotates the substrate; a groove formed on a surface of the substrate so as to surround a rotational axis of the substrate; a phosphor layer formed in the groove; a laser diode that emits laser light delivered to the phosphor layer; and an optical system that guides first light emitted from the phosphor layer excited by the laser light, to the image formation element.

The projection display apparatus according to the present invention includes an illumination optical system including the light source apparatus according to the present invention.

### Advantageous Effects of Invention

The present invention can reduce the etendue of a light source apparatus using a laser light source. The present invention facilitates matching of the etendue of the illumination optical system with the etendue of the projection optical system.

### BRIEF DESCRIPTION OF DRAWINGS

FIG. 1 is a plan view and a side view showing an example of a color wheel relative to the present invention,

FIG. 2 is a plan view and a side view showing another example of a color wheel relative to the present invention,

FIG. 3 is a schematic cross-sectional view of the color wheel shown in FIG. 1 and FIG. 2,

FIG. 4 is a diagram showing a first exemplary embodiment according to the present invention,

FIG. 5 is a plan view and a side view of the color wheel shown in FIG. 4,

FIG. 6 is a schematic cross-sectional view of the color wheel shown in FIG. 4,

FIG. 7 is a schematic cross-sectional view of a variation of the color wheel,

FIG. 8 is a perspective view of the appearance of a projection display apparatus with the light source apparatus shown in FIG. 4,

FIG. 9 is a schematic diagram showing the internal structure of the projection display apparatus shown in FIG. 8, and

FIG. 10 is a diagram showing a second exemplary embodiment according to the present invention.

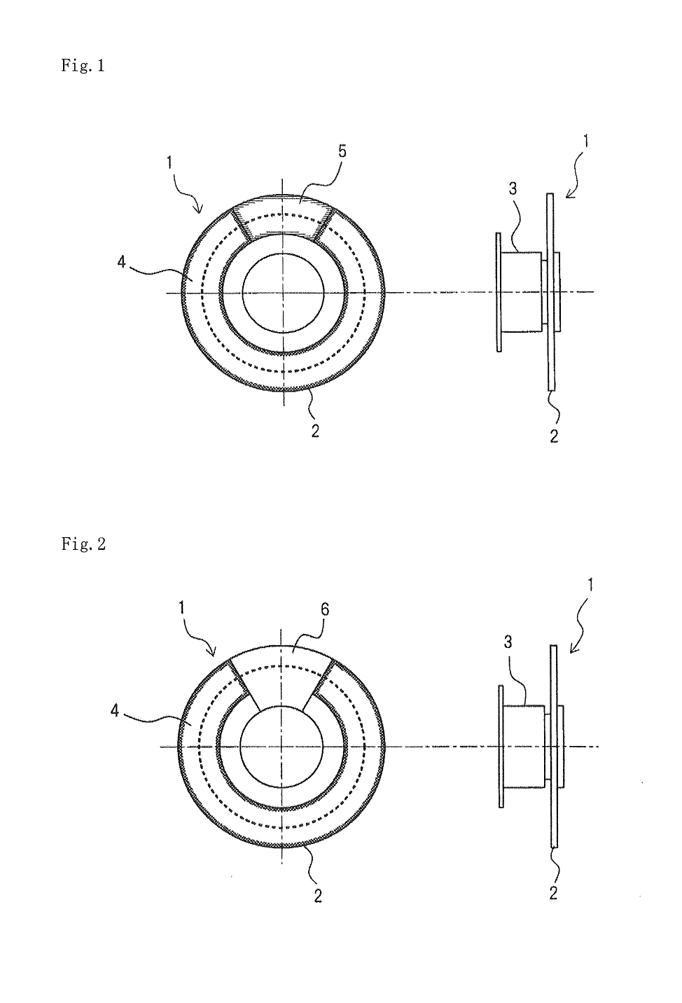

### DESCRIPTION OF EMBODIMENTS

### First Exemplary Embodiment

A first exemplary embodiment according to the present invention will be described below. As shown in FIG. 4, light source apparatus 20 according to the first exemplary embodiment includes laser light source (laser diode) 30 that emits blue laser light, first solid light source (blue light-emitting diode) 40, dichroic mirror 50, color wheel 60, and a plurality of optical elements. Laser diode 30 is hereinafter referred to as “LD 30”. Blue light-emitting diode 40 is hereinafter referred to as “blue LED 40”.

Laser light that is emitted from LD 30 is reflected by dichroic mirror 50, and then enters color wheel 60. The laser light having entered color wheel 60 is converted into red light or green light by a phosphor on color wheel 60. The converted red light or green light is delivered to the illumination target (not shown) via a plurality of optical elements including dichroic mirror 50. On the other hand, blue light that is emitted from blue LED 40 is reflected by dichroic mirror 50, and is delivered to the illumination target via the plurality of optical elements. In short, light source apparatus 20 according to the first exemplary embodiment illuminates the illumination target with the red light and green light obtained by carrying out wavelength conversion on the laser light and the blue light emitted by blue LED 40. The components will be specifically described below.

Dichroic mirror 50 has wavelength selectivity with which dichroic mirror 50 reflects blue light, while allowing red light and green light to transmit through. As shown in FIG. 4, LD 30 and blue LED 40 are arranged opposite each other with dichroic mirror 50 interposed therebetween. Furthermore, a first lens group is arranged between dichroic mirror 50 and color wheel 60, and a second lens group is arranged between dichroic mirror 50 and blue LED 40. The first lens group and the second lens group are collimator lens groups that make light beams parallel to one another.

As shown in FIG. 4, focusing lens 70, rod lens 71, relay lens group 72, and reflection mirror 73 are arranged in this order on an optical path of red light and green light, which are transmitted through dichroic mirror 50. An optical path of blue light that is emitted from blue LED 40 and that is reflected by dichroic mirror 50 is the same as the optical path of the red light and green light, which are transmitted through dichroic mirror 50.

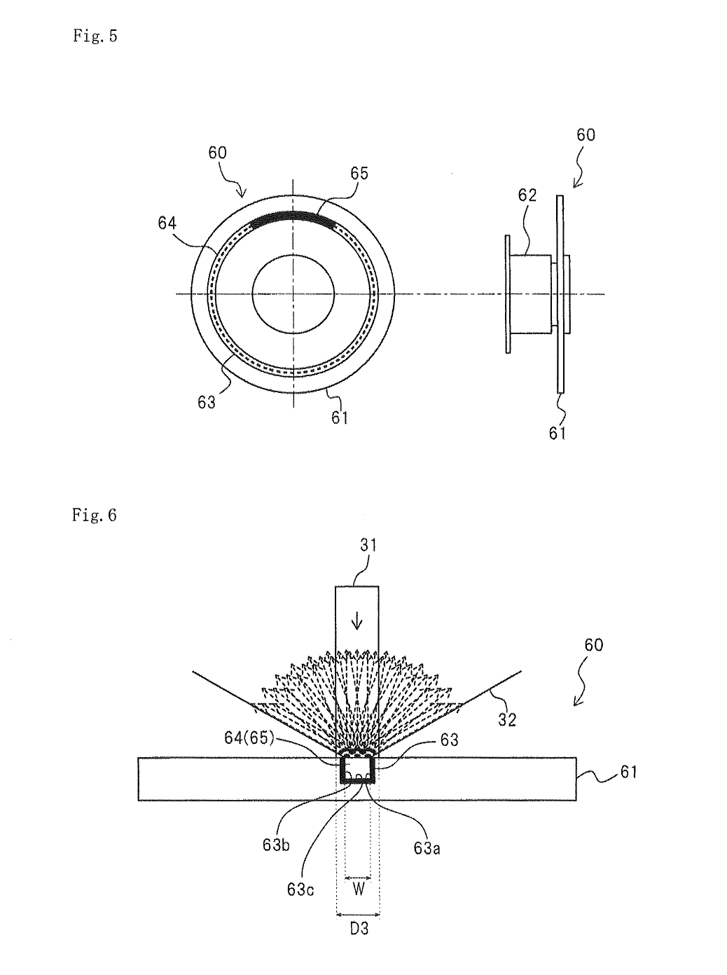

Now, color wheel 60 will be described. As shown in FIG. 5 and FIG. 6, color wheel 60 includes circular glass substrate 61 and driving source (motor 62) configured to rotate glass substrate 61. Illustration of motor 62 is omitted from FIG. 6.

Ring-like recess portion (groove 63) concentric with substrate 61 is formed on a surface of glass substrate 61. A chain line in FIG. 5 shows a trajectory of laser light that is reflected by dichroic mirror 50 (FIG. 4) and that enters glass substrate 61. That is, groove 63 is formed along the trajectory of laser light. In other words, the laser light traces groove 63.

A reflection film (not shown) that is reflects visible light is formed on the inner surfaces of groove 63 (opposite side surfaces 63a and 63b and bottom surface 63c). Moreover, groove 63 is divided into two areas (a first area and a second area) along the circumferential direction of groove 63, and includes first phosphor layer 64 formed on the reflection film in the first area and second phosphor layer 65 formed on the reflection film in the second area. A phosphor that forms first phosphor layer 64 releases green light by being excited by laser light. On the other hand, a phosphor that forms second phosphor layer 65 releases red light by being excited by laser light.

Light that is released from the phosphor that is excited by laser light scatters. Phosphor layers 64 and 65 are provided inside groove 63, and thus, light that is emitted from phosphor layers 64 and 65 is repeatedly reflected inside groove 63. Moreover, as shown in FIG. 6, width (W) of groove 63 is smaller than spot size (D3) of laser light 31. Thus, the diameter of light 32 that is emitted from phosphor layers 64 and 65 is smaller than spot size (D3) of laser light 31. Therefore, when an illumination optical system of a projection display apparatus is configured using light source apparatus 20 shown in FIG. 4, the etendue of the illumination optical system can be easily matched with the etendue of the projection optical system. This advantageously allows the brightness of the projection display apparatus as a whole to be improved.

Additionally, in the first exemplary embodiment, phosphor layers 64 and 65 are stacked on the reflection film formed on inner surfaces 63a, 63b, and 63c of groove 63. Thus, since light that is emitted from phosphor layers 64 and 64 is prevented from being absorbed by glass substrate 61, this leads to a reduced loss.

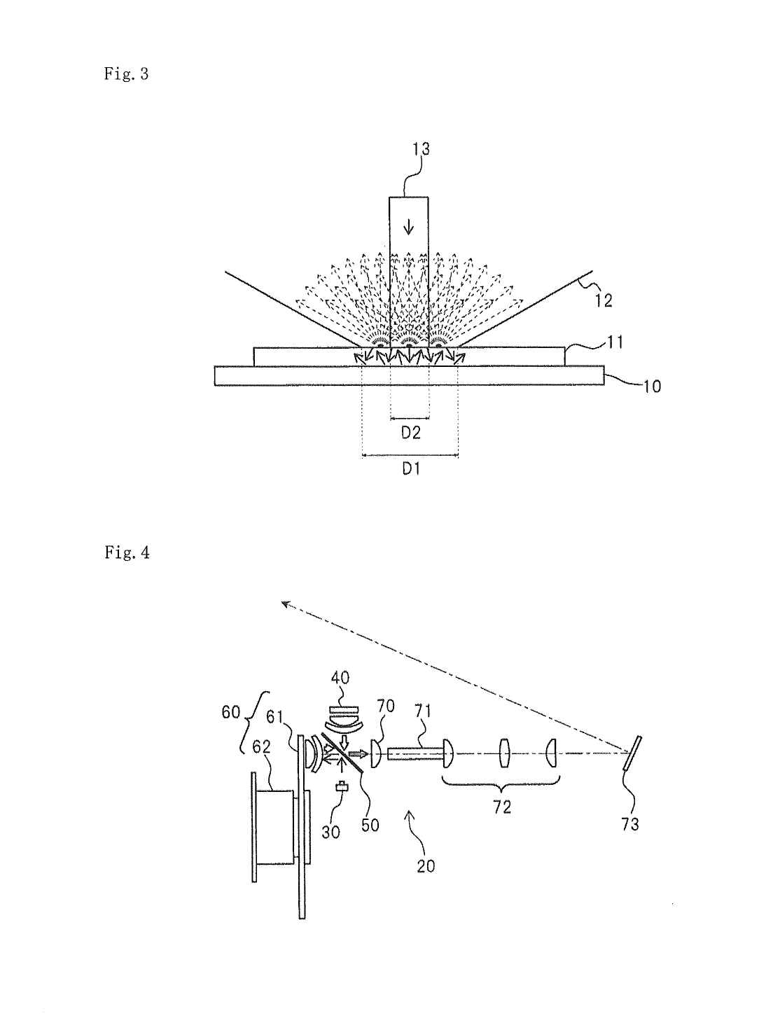

On the other hand, since width (W) of groove 63 is smaller than spot size (D3) of laser light 31, an edge of laser light 31 sticks out from groove 63 as shown in FIG. 6. In other words, the edge of laser light 31 is prevented from being delivered to phosphor layers 64 and 65. However, the intensity distribution of laser light 31 is a Gaussian distribution, and thus, the edge does not have a very high intensity. Thus, the possibility that optical loss will occur is low, and at least the above-described advantages exceed the possible optical loss. The above-described advantages may be obtained even when width (W) of groove 63 is the same as or larger than spot size (D3) of laser light 31. For example, when width (W) of groove 63 is smaller than diameter (D1) of light 12 shown in FIG. 3, the etendue diminishes.

When phosphor layers 64 and 65 are excessively thin, a larger amount of laser light (exciting light) exits color wheel 60 without being subjected to wavelength conversion. On the other hand, when phosphor layers 64 and 65 are excessively thick, a larger amount of light is subjected to wavelength conversion two or more times or is absorbed by the phosphor. The phosphor has a particle size of several tens of micrometer, and thus, the thickness of each of the phosphor layers 64 and 65 is preferably 50 μm or more and 300 μm or less. In other words, the depth of groove 63 is preferably 50 μm or more and 300 μm or less. Indeed, the preferred thickness of each of phosphor layers 64 and 65 varies depending on the particle size of the phosphor.

The operation of light source apparatus 20 will be described with reference to FIG. 4 and FIG. 5. Laser light (blue light) that is emitted from LD 30 is reflected by dichroic mirror 50, and then enters the first lens group. The laser beams having entered the first lens group are made parallel to one another by the first lens group. The laser light that is emitted from the first lens group enters rotating glass substrate 61. Specifically, the light enters the first area or second area of groove 63 shown in FIG. 5. In other words, the laser light enters first phosphor layer 64 or second phosphor layer 65 on glass substrate 61. When the laser light enters first phosphor layer 64, first phosphor layer 64 emits green light. On the other hand, when the laser light enters second phosphor layer 65, second phosphor layer 65 emits red light. The light beams that are emitted from phosphor layer 64 or 65 (green light or red light) are transmitted through the first lens group again and made parallel to one another, and the parallel light beams are transmitted through dichroic mirror 50. The light having been transmitted through dichroic mirror 50 is transmitted through focusing lens 70, rod lens 71, and relay lens group 72 in this order and then enters reflection mirror 73. The light having entered reflection mirror 73 is reflected toward the predetermined illumination target by reflection mirror 73.

On the other hand, light that is emitted from blue LED 40 enters the second lens group. The light beams having entered the second lens group are made parallel to one another by the second lens group. The light that is emitted from the second lens group is reflected by dichroic mirror 50, and then enters focusing lens 70. The light that is emitted from focusing lens 70 is transmitted through rod lens 71 and relay lens group 72 in this order and then enters reflection mirror 73. The light having entered reflection mirror 73 is reflected toward the predetermined illumination target by reflection mirror 73.

The luminance distribution of the light (red light, green light, and blue light) is made even while the light is passing through rod lens 71. Furthermore, the cross section of the light (luminous flux) that is emitted from rod lens 71 is shaped into a substantial rectangle. Moreover, the cross section of the light that is delivered to the illumination target by reflection mirror 73 is slightly larger than the illumination area on the illumination target.

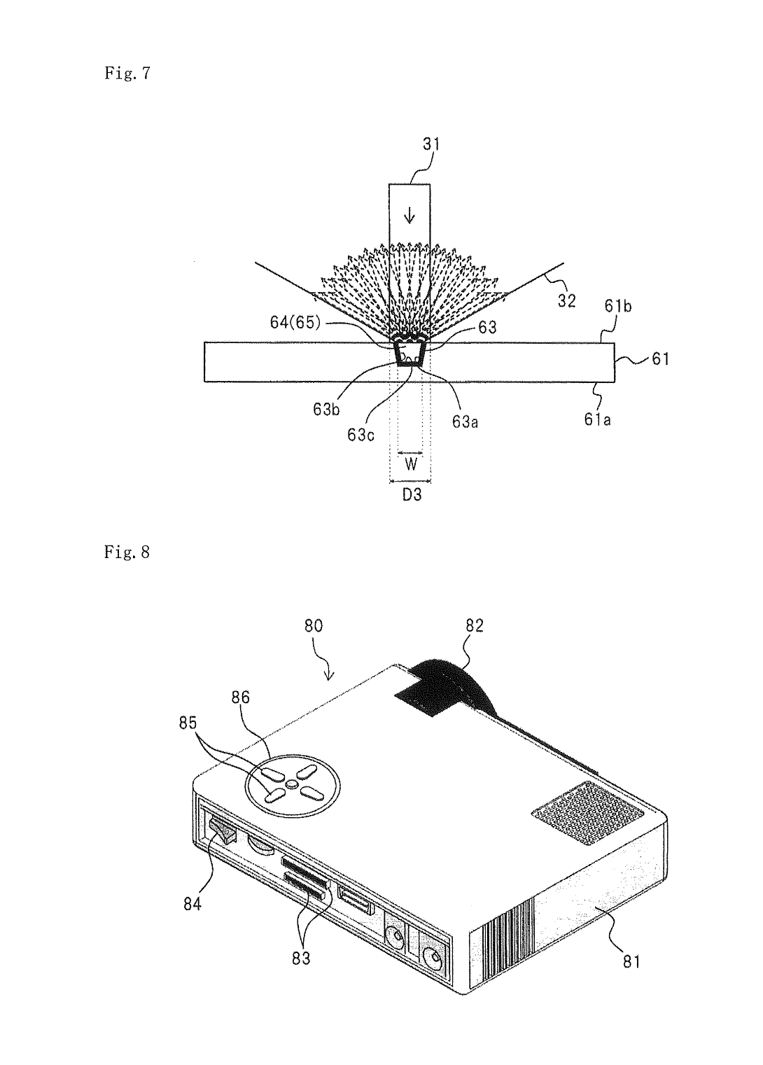

FIG. 7 shows a variation of the color wheel. Color wheel 60 shown in FIG. 6 is different from color wheel 60 shown in FIG. 7 in the cross section of groove 63. The width of groove 63 on color wheel 60 shown in FIG. 6 is constant. On the other hand, the width of groove 63 on color wheel 60 shown in FIG. 7 is not constant. Specifically, the width of groove 63 increases from back surface side 61a toward front surface side 61b of glass substrate 61. In other words, the distance between opposite side surfaces 63a and 63b gradually increases. In other words more, opposite side surfaces 63a and 63b are inclined so as to separate from each other. As a result, the angles between bottom surface 63c and each side surface 63a and 63b of groove 63 are larger than 90 degrees. Indeed, the maximum width of groove 63 is smaller than spot size (D3) of laser light 31.

The light that is emitted from the phosphor is reflected by the reflection film formed on side surfaces 63a and 63b inclined as described above. As a result, the angle distribution of light 32 that is emitted from phosphor layers 64 and 65 is reduced, further decreasing the diameter of light 32.

Glass substrate 61 may be changed to a metal substrate (for example, an aluminum substrate). The reflection film may be formed of an optical multilayer film or a metal film. Dichroic mirror 50 may be changed to a cross dichroic prism. Rod lens 71 may be changed to a lens array.

Groove 63 may be divided into three or more areas along the circumferential direction of groove 63, and different phosphor layers may be formed in the respective areas. For example, a phosphor layer that is configured to emit green light is formed in a first area, a phosphor layer that is configured to emit red light is formed in a second area, and a phosphor layer that is configured to emit blue light is formed in a third area. In this case, blue LED 40 shown in FIG. 4 may be omitted. Furthermore, when groove 63 is partitioned into three or more areas, the same phosphor layer may be formed in two or more areas.

FIG. 8 is a perspective view of the appearance of projection display apparatus 80 with light source apparatus 20 shown in FIG. 4. Projection display apparatus 80 includes housing 81 formed of a synthetic resin. Projection lens 82 is provided on a front surface of housing 81, and various connectors 83, power supply switch 84, and the like are provided on a rear surface of housing 81. Furthermore, operation panel 86 including a plurality of operation buttons 85 is provided on an upper surface of housing 81.

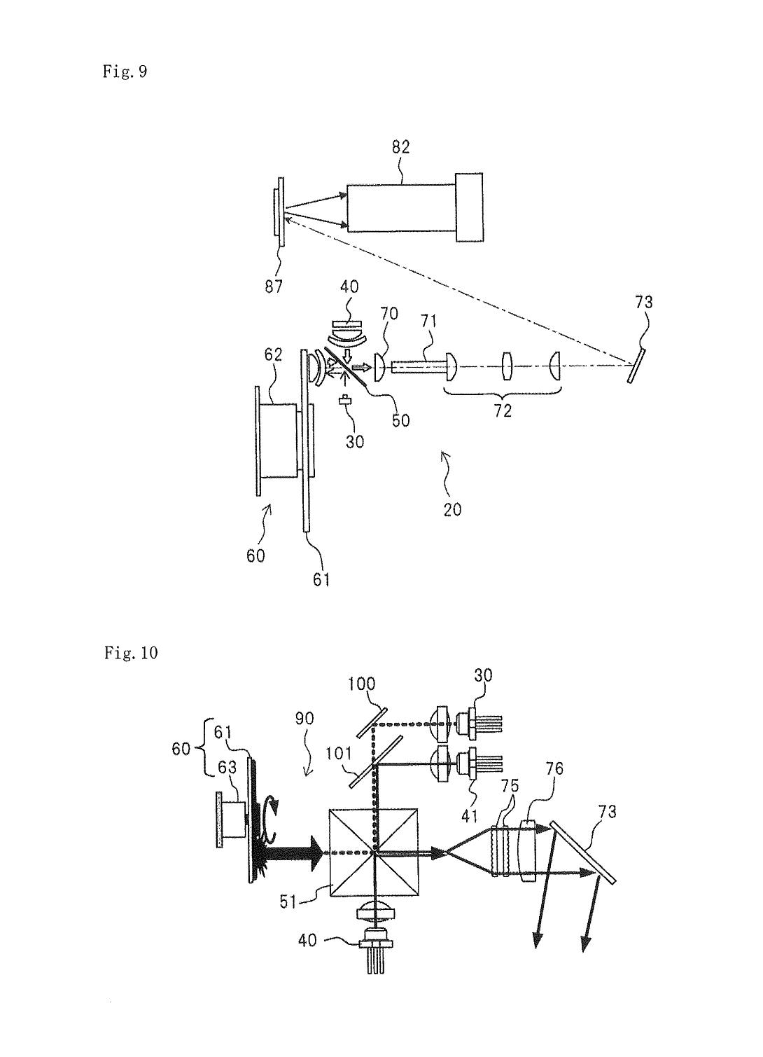

FIG. 9 is a schematic diagram showing the internal structure of projection display apparatus 80 shown in FIG. 8. Projection display apparatus 80 includes DMD 87 as an image formation element. DMD 87 is illuminated by light source apparatus 20. Specifically, light that is reflected by reflection mirror 73 in light source apparatus 20 is delivered to DMD 87. DMD 87 modulates the delivered light in accordance with a video signal to form image light. The formed image light is projected on a screen (not shown) via projection lens 82.

DMD 87 and light source apparatus 20 are synchronized with each other. Specifically, the rotation angle and rotation speed of glass substrate 61 and light emission timings for LD 30 are set so as to irradiate second phosphor layer 65 (FIG. 5) with laser light when DMD 87 is to display a red color. Furthermore, the rotation angle and rotation speed of glass substrate 61 and light emission timings for LD 30 are set so as to irradiate first phosphor layer 64 (FIG. 5) with laser light when DMD 87 is to display a green color. Moreover, the rotation angle and rotation speed of glass substrate 61 and light emission timings for blue LED 40 and LD 30 are set so as to allow blue LED 40 to emit light while avoiding irradiation of glass substrate 61 with laser light when DMD 87 is to display a blue color.

Instead of DMD 87, a liquid crystal panel may be used as an image formation element.

### Second Exemplary Embodiment

A second exemplary embodiment of the light source apparatus will be described below. FIG. 10 is a schematic diagram showing a configuration of light source apparatus 90 according to this exemplary embodiment. A basic configuration of light source apparatus 90 according to this exemplary embodiment is the same as the basic configuration of light source apparatus 20 according to the first exemplary embodiment. Thus, only differences from light source apparatus 20 will be described below, and aspects common to light source apparatus 90 and 20 will not be described.

Light source apparatus 90 includes second solid light source (red light-emitting diode) 41 in addition to LD 30 and blue LED 40. Furthermore, light source apparatus 90 uses cross dichroic prism 51 instead of dichroic mirror 50 shown in FIG. 4 and uses lens array 75 instead of rod lens 71. Moreover, only a first phosphor layer (not shown) is provided inside a groove (not shown) in glass substrate 61. Red light-emitting diode 40 is hereinafter referred to as “red LED 41”.

The operation of light source apparatus 90 will be described. Laser light (blue light) that is emitted from LD 30 is reflected by reflection mirror 100, and then enters cross dichroic prism 51. The light having entered the cross dichroic prism 51 is reflected by a refection film in the prism, and then enters rotating glass substrate 61. Specifically, the laser light enters the first phosphor layer on glass substrate 61, and the first phosphor layer emits green light. The green light that is emitted from the first phosphor layer enters cross dichroic prism 51 again. The green light having entered cross dichroic prism 51 is transmitted through the reflection film in the prism and enters lens array 75.

Light (red light) that is emitted from red LED 41 is reflected by reflection mirror 101, and then enters cross dichroic prism 51. The red light having entered cross dichroic prism 51 is reflected by the refection film in the prism, and them enters lens array 75.

Light (blue light) that is emitted by blue LED 40 enters cross dichroic prism 51. The blue light having entered cross dichroic prism 51 is reflected by the refection film in the prism, and them enters lens array 75.

The light in the respective colors having entered lens array 75 as described above is split into a plurality of rectangular light sources by lens array 75. The resultant rectangular light sources illuminate the predetermined illumination target via condenser lens 76 and reflection mirror 73. At this time, condenser lens 76 superimposes the plurality of rectangular light sources on one another on the illumination target. As a result, the illumination target is illuminated with light having a necessary and sufficient magnitude and a uniform luminance distribution.

A collimator lens group may be provided as necessary on an optical path shown in FIG. 10. Furthermore, of course, light source apparatus 20 shown in FIG. 9 can be substituted with light source apparatus 90.

As well, the laser light source is not limited to the laser diode (semiconductor laser) but may be a solid laser, a liquid laser, a gas laser, or the like. In addition, the solid light source is not limited to the LED but may be a laser light source. In this case, laser light that is emitted by the laser light source is utilized without change, and thus, a low-power laser light source is preferably used.

### REFERENCE SIGNS LIST

20, 90 Light source apparatus
30 Laser diode (LD)
40 Blue light-emitting diode (blue LED)
41 Red light-emitting diode (red LED)
50 Dichroic mirror
51 Dichroic prism
60 Color wheel
61 Glass substrate
62 Motor
63 Groove
64 First phosphor layer (green phosphor layer)
65 Second phosphor layer (red phosphor layer)
70 Focusing lens
71 Rod lens
72 Relay lens group
73 Reflection mirror
75 Lens array

What is claimed is:

1. A light source apparatus for illuminating an image formation element, comprising:
a substrate;
a driving source that rotates said substrate;
a groove formed on a surface of said substrate so as to surround a rotational axis of said substrate;
a phosphor layer formed in said groove;
a laser light source that emits laser light delivered to said phosphor layer; and
an optical system that guides first light emitted from said phosphor layer excited by the laser light, to the image formation element.

2. The light source apparatus according to claim 1, wherein a width of said groove is smaller than a spot size of the laser light on said substrate.

3. The light source apparatus according to claim 1, comprising a first solid light source that emits second light belonging to a wavelength band different from a wavelength band to which the first light belongs, wherein
said optical system guides the first light and the second light to the image formation element.

4. The light source apparatus according to claim 3, wherein a first phosphor layer and a second phosphor layer are formed in said groove along a rotating direction of said substrate,
the first phosphor layer emits the first light by being exciting by the laser light,
the second phosphor layer emits third light by being excited by the laser light, the third light belonging to a wavelength band different from wavelength bands to which the first light and the second light belong, and
said optical system guides the first to the third light to the image formation element.

5. The light source apparatus according to claim 3, comprising a second sold light source that emits third light belonging to a wavelength band different from wavelength bands to which the first light and the second light belong, and
said optical system guides the first to the third light to the image formation element.

6. The light source apparatus according to claim 1, wherein a reflection film is formed on an inner surface of said groove, and said phosphor layers are stacked on said reflection film.

7. The light source apparatus according to claim 1, wherein the width of said groove is constant.

8. The light source apparatus according to claim 1, wherein the width of said groove gradually increases from a back surface side toward a front surface side of said substrate.

9. A projection display apparatus comprising an image formation element, an illumination optical system that illuminates said image formation element, and a projection optical system that projects light emitted from said image formation element,
wherein said illumination optical system includes the light source apparatus according to claim 1.
